(19) United States
(12) Patent Application Publication
(10) Pub. No.: US 2018/0165629 A1
(43) Pub. Date: Jun. 14, 2018

(54) NON-TRANSITORY COMPUTER-READABLE RECORDING MEDIUM RECORDING INVENTORY DEPLOYMENT SITE DETERMINATION PROGRAM, INFORMATION PROCESSING APPARATUS, AND INVENTORY DEPLOYMENT SITE DETERMINATION METHOD

(71) Applicant: FUJITSU LIMITED, Kawasaki-shi (JP)

(72) Inventor: MIHO OKAMOTO, Kawasaki (JP)

(73) Assignee: FUJITSU LIMITED, Kawasaki-shi (JP)

(21) Appl. No.: 15/887,031

(22) Filed: Feb. 2, 2018

Related U.S. Application Data
(63) Continuation of application No. PCT/JP2016/067006, filed on Jun. 8, 2016.

(30) Foreign Application Priority Data
Sep. 7, 2015 (JP) 2015-176113

(51) Int. Cl. G06Q 10/08

(52) U.S. Cl. CPC G06Q 10/087

(57) ABSTRACT

A non-transitory computer-readable recording medium recording an inventory deployment site determination program that causes a computer to execute a process, the process includes: determining an index value about a possibility that a placement location for each of, products to be maintenance targets is changed based on history information of placement locations of the products; and determining, for each of the products, a warehouse as a deployment site of an inventory of a component of the respective products based on the index value that Corresponds to the respective products.

### CROSS-REFERENCE TO RELATED APPLICATION

This application is a continuation application of International Application PCT/JP2016/067006 filed on Jun. 8, 2016, designated the US. and based upon and claiming the benefit of priority of the prior Japanese Patent Application No. 2015-176113, filed on Sep. 7, 2015, the entire contents of which are incorporated herein by reference.

### FIELD

The embodiment discussed herein is related to a non-transitory computer-readable recording medium recording an inventory deployment site determination program, an information processing apparatus, and an inventory deployment site determination method.

### BACKGROUND

As for a product to be a target of a maintenance service, for example, the information that indicates a placement location of the product (hereinafter referred to as “placement location information”) may be registered as a portion of information of a customer who purchases the product for the purpose of improving the maintenance service. An example of related art is disclosed in Japanese Laid-open Patent Publication No 2002-99768.

### SUMMARY

According to an aspect, of the embodiments, a non-transitory computer-readable recording medium recording an inventory deployment site determination program that causes a computer to execute a process, the process comprising: determining an index value about a possibility that a placement location for each of products to be maintenance targets is changed based on history information of placement locations of the products; and determining, for each of the products, a warehouse as a deployment site of an inventory of a component of the respective products based on the index value that corresponds to the respective products.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates a configuration example of a maintenance work support system in an embodiment of the present disclosure;

FIG. 2 is a diagram that illustrates a hardware configuration example of a customer management device in the embodiment of the present disclosure;

FIG. 3 is a diagram that explains an outline of the embodiment of the present disclosure;

FIG. 4 is a diagram for explaining the nearest warehouse and a block warehouse;

FIG. 5 is a diagram that illustrates a function configuration example of the maintenance work support system in the embodiment of the present disclosure;

FIG. 6 is a sequence diagram for explaining one example of process procedures of a registration process of customer information;

FIG. 7 is a diagram that illustrates a configuration example of a record of a maintenance information storage unit;

FIG. 8 is a sequence diagram for explaining one example of process procedures of a shipment process of a maintenance component in response to occurrence of trouble with a product;

FIG. 9 is a diagram that illustrates a configuration example of a maintenance component list storage unit;

FIG. 10 is a diagram that illustrates a configuration example of a placement location precision storage unit;

FIG. 11 is a diagram that illustrates a configuration example of a record of a shipment result storage unit;

FIG. 12 is a sequence diagram for explaining one example of process procedures of an assessment process of a placement location precision;

FIG. 13 is a diagram that illustrates a configuration example of data which indicate presence or absence of a change of a placement location with respect to each product as a maintenance target;

FIG. 14 is a flowchart for explaining one example of process procedures of a determination process of a deployment site of the maintenance component;

FIG. 15 is a diagram that illustrates a configuration example of an inventory information storage unit; and

FIG. 16 is a sequence diagram for explaining one example of second process procedures of the registration process of the customer information.

### DESCRIPTION OF EMBODIMENT

A company that provides a maintenance service (hereinafter referred to as “maintenance service provider”) selects a deployment site of an inventory of a component of the product from plural warehouses based on the registered placement location information. For example, a case is considered where the inventory of the component is deployed to a warehouse nearest to the placement location. Accordingly, in a case where a notification about occurrence of trouble with the product is received from a customer, the maintenance service provider may quickly procure a requested component from the warehouse nearest to the placement location of the product.

However, a placement location of a product may be changed by the reason of movement or the like of a base of a customer. The change of the placement location may not be immediately notified to a maintenance service provider. For example, the maintenance service provider may know the change of the placement location of the product in a case of a notification of occurrence of trouble with the product from the customer. In such a case, it is possible that the nearest warehouse to a new placement location is short of inventories of components requested for solving the trouble and a delay in procurement of the components occurs.

Meanwhile, in a case where the inventories of each product are excessively deployed for each warehouse in order to avoid the delay in procurement of the components, the cost for inventory management may increase.

For example, occurrence of a delay in procurement of a component may be reduced while suppressing an increase in the number of inventories of components.

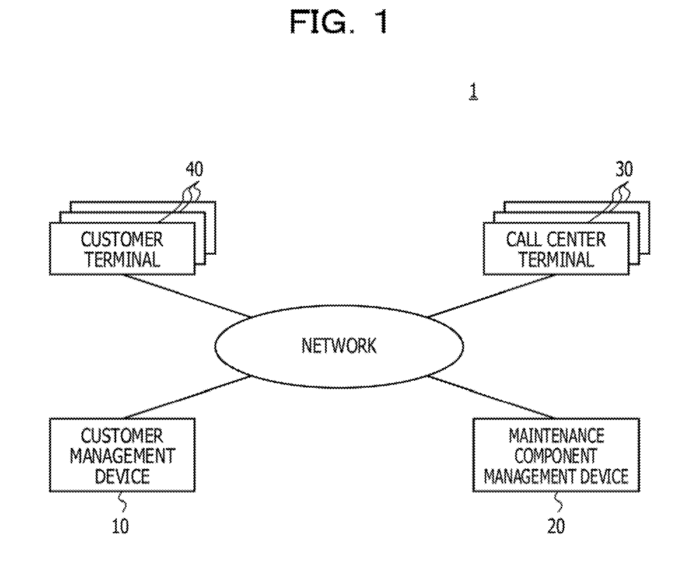

An embodiment of the present disclosure will hereinafter be described with reference to drawings. FIG. 1 is a diagram that illustrates a configuration example of a maintenance work support system in the embodiment of the present disclosure. A maintenance work support system 1 is a computer system that is run by a company which provides maintenance services for plural kinds of products (hereinafter referred to as “maintenance service provider”), for example. In the maintenance work support system 1 illustrated in FIG. 1, a customer management device 10, a maintenance component management device 20, a call center terminal 30, a customer terminal 40, and so forth are connected via a network such as the Internet or a local area network (LAN) so as to be capable of communication.

The customer management device 10 is one or more computers that manage information about customers and information about products which are used by customers. A customer is a user of a product to be a target of a maintenance service, for example.

The maintenance component management device 20 is one or more computers that manage information about components which configure products as targets of maintenance services (hereinafter referred to as “maintenance component”).

The call center terminal 30 is a terminal that is used by an operator or the like of a call center who accepts an inquiry or the like about the product from the customer.

The customer terminal 40 is a terminal that is used by a customer. The customer terminal 40 is placed in an office or the like of the customer, for example.

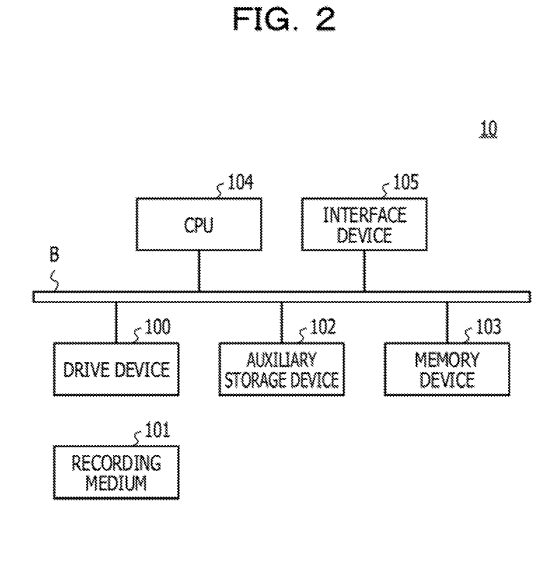

FIG. 2 is a diagram that illustrates a hardware configuration example of the customer management device in the embodiment of the present disclosure. The customer management device 10 in FIG. 2 has a drive device 100, an auxiliary storage device 102, a memory device 103, a CPU 104, an interface device 105, and so forth, which are mutually connected by a bus B.

A program that realizes a process in the customer management device 10 is provided by a recording medium 101. When the recording medium 101 that records the program is set in the drive device 100, the program is installed in the auxiliary storage device 102 from the recording medium 101 via the drive device 100. However, the installation of the program does not necessarily have to be performed by the recording medium 101. The program may be downloaded from another computer via the network. The auxiliary storage device 102 stores the installed program and stores desired files, data, and so forth.

In a case where a start instruction of the program is provided, the memory device 103 reads out the program from the auxiliary storage device 102 and stores the program. The CPU 104 executes a function related to the customer management device 10 in accordance with the program stored in the memory device 103. The interface device 105 is used as an interface for connection with the network.

Note that examples of the recording medium 101 include a portable recording medium such as a CD-ROM, a DVD disk, and a USB memory. Further, examples of the auxiliary storage device 102 include a hard disk drive (HDD), a flash memory, and the like. Both of the recording medium 101 and the auxiliary storage device 102 are correspondent to a computer-readable recording medium.

Note that the maintenance component management device 20 may have a hardware configuration as illustrated in FIG. 2.

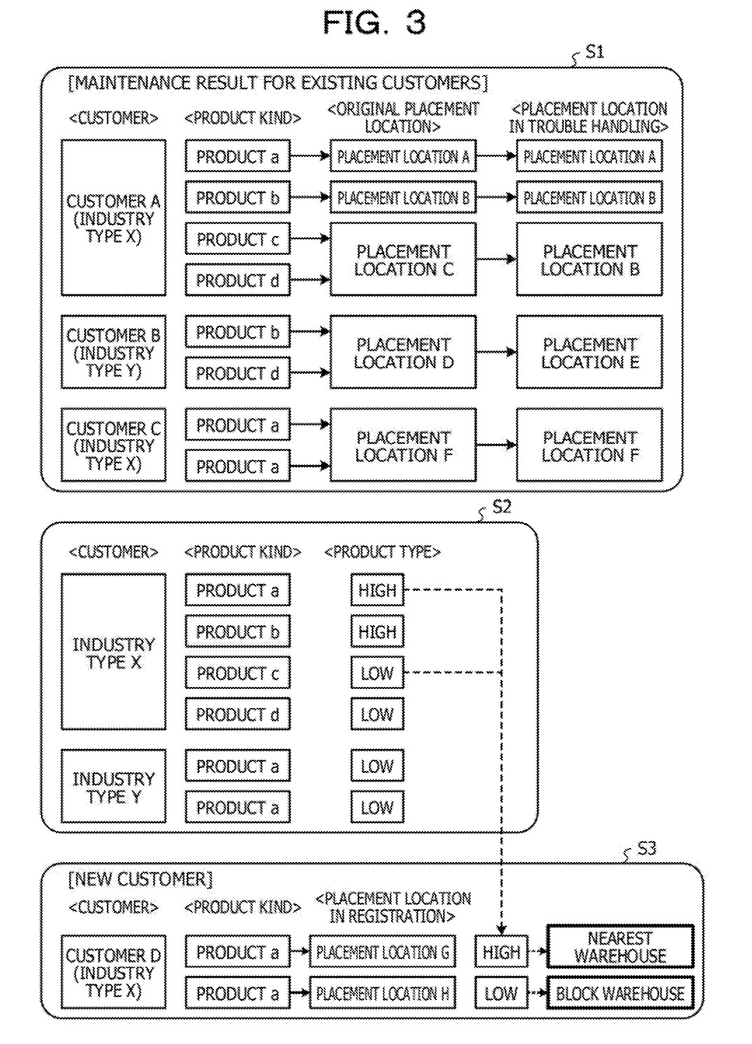

FIG. 3 is a diagram that explains an outline of the embodiment of the present disclosure. In FIG. 3, maintenance results for existing customers are illustrated in the frame indicated by S1. For example, an example is illustrated where a customer A whose industry type is X, a customer B whose industry type is Y, and a customer C whose industry type is X are the customers. Further, for each of the customers, used products, original placement locations of the respective products, placement locations in trouble handling, and so forth are illustrated. An original placement location is the first placement location at a time after purchase of the product, for example. A placement location in trouble handling is a placement location of the product that is reported in inquiry from the customer in a case where trouble occurs to the product, for example.

For example, the customer A uses a product a, a product b, a product c, and a product d. As for the product a among those, both of the original placement location and the placement location in trouble handling are a placement location A. That is, as for the product a, the placement location is not changed. Further, the product b is not moved from a placement location B either. On the other hand, as for the product c and the product d, the original placement location is a placement location C, but the placement location in trouble handling is the placement location B. Note that the alphabets (a to d) attached to the products indicate the kinds of products (for example, models).

In the frame of S2, the pieces of information indicated in the frame of S1 are categorized into industry types and product kinds, and the results of assessments of placement location precisions are indicated for the respective categories. A placement location precision is an index that indicates the precision of the original placement location with respect to the present placement location of the product. In other words, the placement location precision is an index that indicates the degree of the possibility that the placement location is changed. In FIG. 3, the placement location precisions are two levels of “high” and “low”. “High” indicates that the precision of the original placement location is high, that is, the possibility that the placement location is changed is low. “Low” indicates that the precision of the original placement location is low, that is, the possibility that the placement location is changed is high.

In FIG. 3, as for the industry type X, an, example is illustrated where the placement location precisions of the product a and the product b are “high” and the placement location precisions of the product c and the product d are “low”. Further, as for the industry type Y, a fact that the placement location precisions of the product b and the product d are “low” is illustrated.

Note that the placement location precisions are assessed with respect to the product kinds because it is considered that the possibility that the placement location is changed is common for each of the product kinds, for example, as the products such as smartphones and PCs that are highly portable and used by individuals are highly movable. Further, the placement location precisions are assessed with respect to the industry types because it is considered that the ways of use or importance degrees of even the same products are different in accordance with the industry types and that the movability of highly important products is low (the possibility that the placement location is changed is low), for example.

Next, in the frame of S3, a determination method of deployment sites of the maintenance components about the products for a new customer D is illustrated, for example.

The industry type of the customer D is the industry type X, and the customer D uses the product a and the product c. In the frame S2, the placement location precision of the product a for the industry type X is “high”, the placement location precision of the product c is “low”. Therefore, the deployment site of the maintenance components of the product a for the customer D is set as the “nearest warehouse”. On the other hand, the deployment site of the maintenance components of the product c for the customer D is set as a “block warehouse”.

Here, the nearest warehouse is a warehouse that is nearest to the placement location of the product among the warehouses which the maintenance service provider has. Meanwhile, a block warehouse is a warehouse that is selected for each district (block) which includes plural warehouses. For example, in a case where the warehouses are categorized for each block such as the Kanto region, the Kinki region, the Chugoku region, or the Shikoku region, the warehouse that has the, highest accessibility and the most surpassing distribution mobility may be selected as the block warehouse.

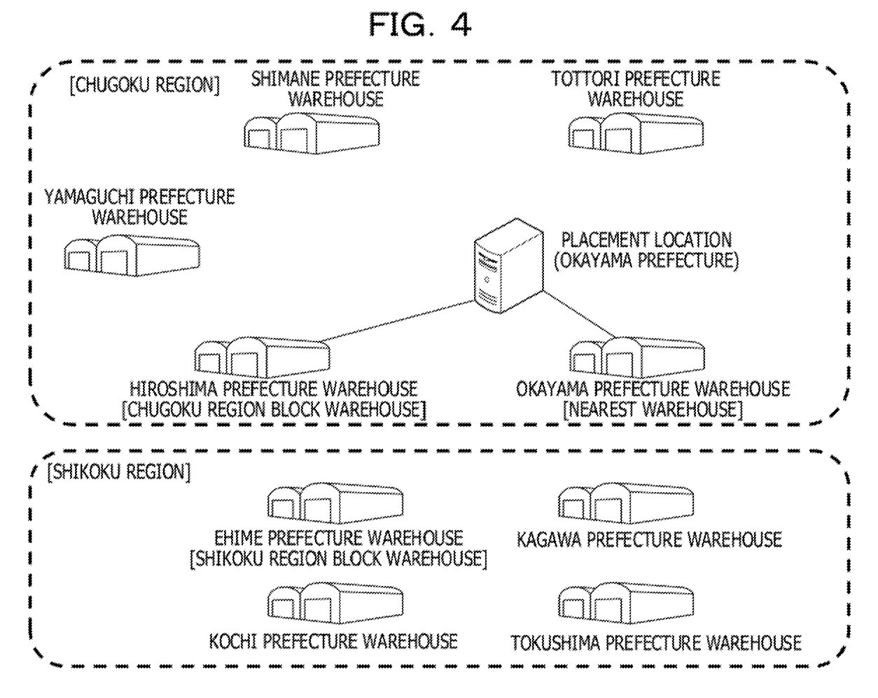

FIG. 4 is a diagram for explaining the nearest warehouse and the block warehouse. FIG. 4 illustrates examples of the nearest warehouse and the block warehouse for the product that is placed in Okayama Prefecture. The nearest warehouse for the product is a warehouse located in Okayama Prefecture, and the block warehouse is the block warehouse of the Chugoku region.

That is, in this embodiment, the maintenance components of the product whose placement location precision is “high” are deployed to the closest warehouse to the placement location of the product. Accordingly, in a case where trouble occurs to the product, the maintenance component may quickly be delivered to the placement location. On the other hand, the maintenance components of the product whose placement location precision is “low” are deployed to the block warehouse for the placement location of the product. Accordingly, in a case where the product is moved, a serious delay in procurement of the maintenance component may be avoided.

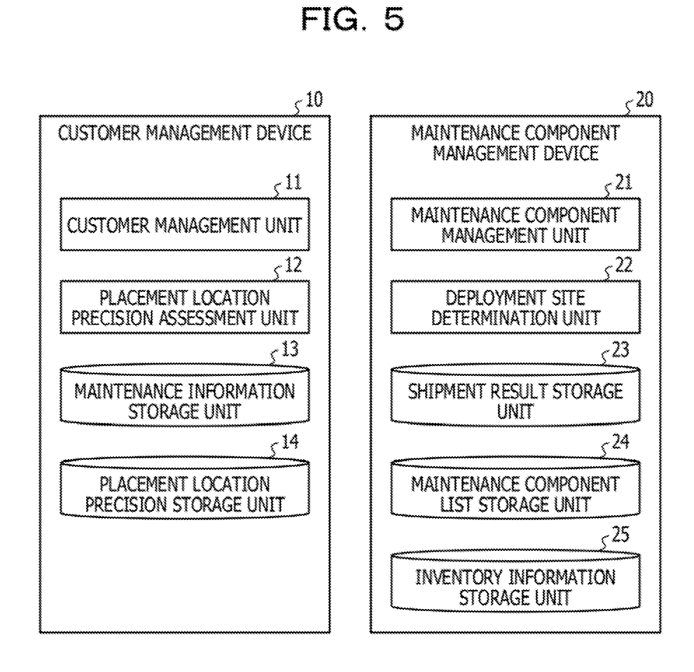

To enable the above deployment of the maintenance components, the maintenance work support system 1 has a function configuration as illustrated in FIG. 5, for example.

FIG. 5 is a diagram that illustrates a function configuration example of the maintenance work support system in the embodiment of the present disclosure. In FIG. 5, the customer management device 10 has a customer management unit 11, a placement location precision assessment unit 12, and so forth. Those units are realized by a process that one or more programs installed in the customer management device 10 causes the CPU 104 to execute. The customer management device 10 also uses a maintenance information storage unit 13, a placement location precision storage unit 14, and so forth. It is possible to realize each of those storage units by using the auxiliary storage device 102 or a storage device or the like that is connectable with the customer management device 10 via the network, for example.

The customer management unit 11 performs addition of information to the maintenance information storage unit 13, read-out of information stored in the maintenance information storage unit 13, and so forth. The maintenance information storage unit 13 stores information about each of the customers, information of the product used by each of the customers, and so forth.

The placement location precision assessment unit 12 assesses or determines the placement location precision with respect to each combination of the model of the product and the industry type of the customer, whose pieces of information are stored in the maintenance information storage unit 13. The placement location precision is assessed based on history information of the placement location of each of the products. The history information of the placement location of each of the products is specified based on information that is stored in the maintenance information storage unit 13 and that indicates the original placement location of each of the products, information that is stored in a shipment result storage unit 23 of the maintenance component management device 20 in response to maintenance work in occurrence of trouble with each of the products and that indicates the placement location of each of the products in the occurrence of trouble, and so forth. The placement location precision assessment unit 12 stores the placement location precision that is assessed with respect to each combination of the model of the product and the industry type of the customer in the placement location precision storage unit 14.

The maintenance component management device 20 has a maintenance component management unit 21, a deployment site determination unit 22, and so forth. Those units are realized by a process that one or more programs installed in the maintenance component management device 20 causes a CPU of the maintenance component management device 20 to execute. The maintenance component management device 20 also uses the shipment result storage unit 23, a maintenance component list storage unit 24, an inventory information storage unit 25, and so forth. It is possible to realize each of those storage units by using an auxiliary storage device of the maintenance component management device 20 or a storage device or the like that is connectable with the maintenance component management device 20 via the network, for example.

The maintenance component management unit 21 performs writing of information in the shipment result storage unit 23, the maintenance component list storage unit 24, the inventory information storage unit 25, and so forth, read-out of information from each of those storage units, and so forth. At each time when the maintenance component is shipped in response to trouble or the like with the product as the maintenance target, the shipment result storage unit 23 stores the information about the shipment. The information about shipment includes information that indicates a shipment destination of the maintenance component. The information that indicates the shipment destination of the maintenance component is dealt with as information that indicates the newest placement location of the product

The maintenance component list storage unit 24 stores information that indicates a catalog of the maintenance components which configure the product with respect to each of the products. The inventory information storage unit 25 stores the number of inventories or the like of each of the maintenance components in each of the warehouses.

The deployment site determination unit 22 determines the warehouse to be the deployment site of the inventories of the maintenance components related to each of the products based on the placement location precision of each of the products.

Note that the customer management device 10 and the, maintenance component management device 20 may be realized by a common computer. In this case, functions of the customer management device 10 and functions of the maintenance component management device 20 may be realized by processes that the program installed in the computer causes the computer to execute.

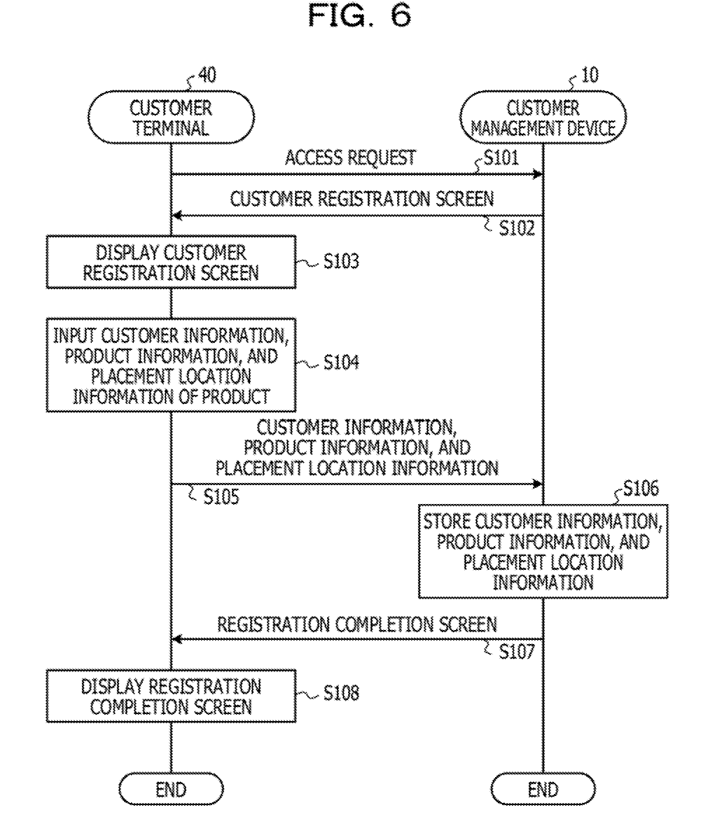

A description will hereinafter be made about process procedures that are executed'in the maintenance work support system 1. FIG. 6 is a sequence diagram for explaining one example of process procedures of a registration process of customer information. The process procedures in FIG. 6 are executed in a case where the customer purchases the product.

In step S101, the customer terminal 40 of a certain customer transmits an access request to the customer management device 10 in accordance with an operation by a user in the customer. The customer management unit 11 of the customer management device 10 replies to the customer terminal 40 with display data of a customer registration screen in response to the access request (S102). The customer terminal 40 displays the customer registration screen based on the display data (S103).

In a case where the user inputs, to the customer registration screen, the customer information, product information of a purchased product, placement location information of the product, and so forth (S104), the customer terminal 40 transmits the input information to the customer management device 10 (S105). The customer management unit 11 of the customer management device 10 stores the information in the maintenance information storage unit 13 (S106).

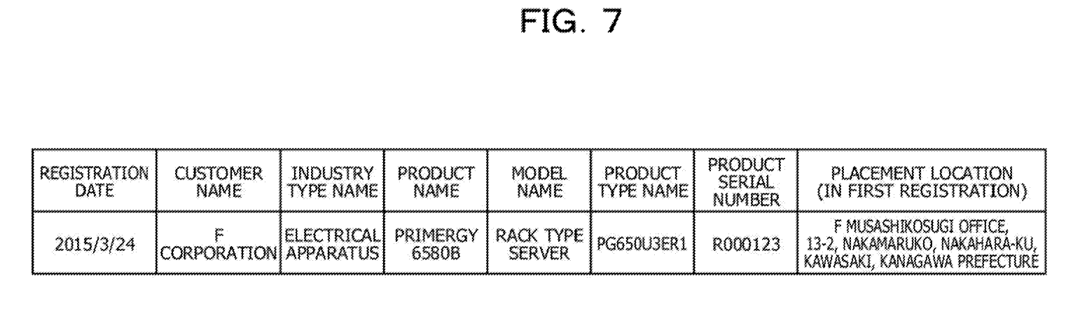

FIG. 7 is a diagram that illustrates a configuration example of a record of the maintenance information storage unit. As illustrated in FIG. 7, the record of the maintenance information storage unit 13 (hereinafter referred to as “maintenance information record”) includes items such as a registration date, a customer name, an industry type name, a product name, a model name, a product type name, a product serial number, and the placement location.

The registration date is the year, month, and day when the maintenance information record is registered. The customer name is the name of the customer. Then industry type name is the name of the industry type of the customer. The product name is the name of the product. The model name is the name of the model (kind) of the product. The product type name is the type name of the product. The product serial number is the identification information of an individual of the product. Strictly, each individual of the product is identified by the combination of the product type name and the product serial number. The placement location is information that indicates the placement location of the product (for example, address).

Note that the maintenance information record is registered for each of the products. Therefore, in a case where plural products are purchased by a certain customer, the maintenance information record is registered for each of the products.

Next, the customer management nit 11 transmits display data of a registration completion screen to the customer terminal 40 (S107). In a case where the customer terminal 40 receives the display data, the customer terminal 40 displays the registration completion screen based on the display data (S108),

Next, a description will be made about process procedures that are executed in shipment of the maintenance component in a case where trouble or the like occurs to the product used by the customer. Shipment of the maintenance component is delivery from the warehouse of the maintenance component that is reserved in the warehouse.

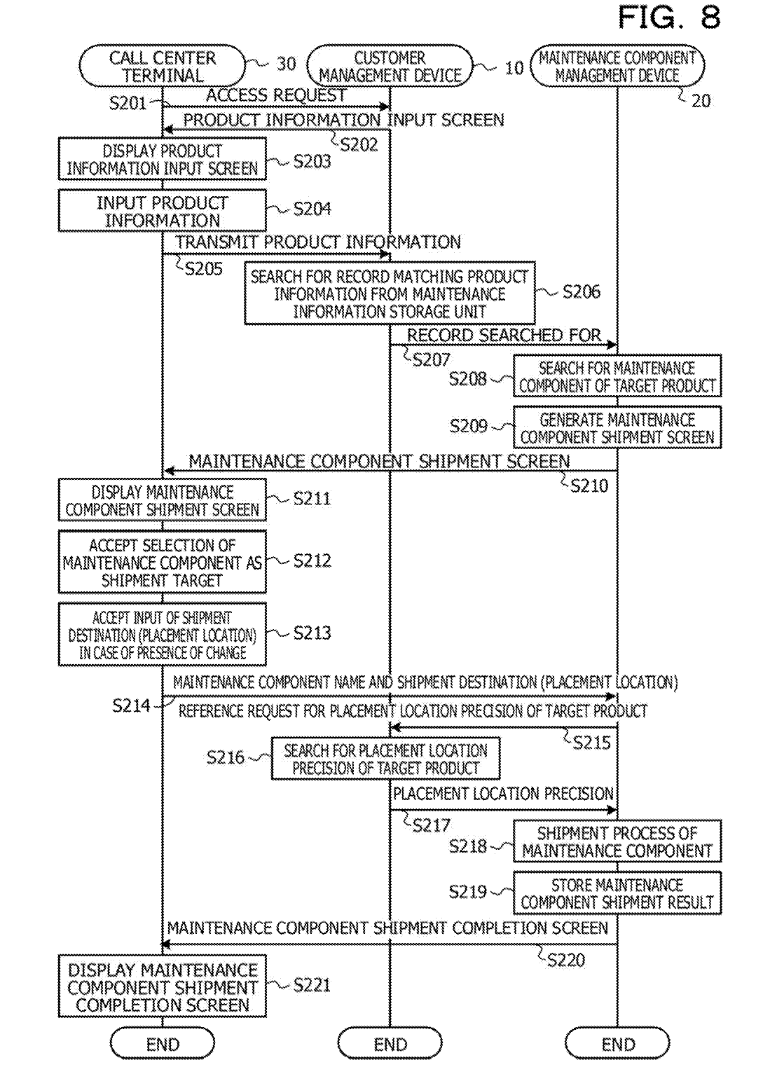

FIG. 8 is a sequence diagram for explaining one example of process procedures of a shipment process of the maintenance component in response to occurrence of trouble with the product.

For example, the call center terminal 30 transmits the access request to the customer management device 10 in accordance with an operation by the operator of the call center who accepts a report of occurrence of trouble with the product from the customer (S201). The customer management unit 11 of the customer management device 10 replies to the call center terminal 30 with display data of a product information input screen in response to the access request (S202). The call center terminal 30 displays the product information input screen based on the display data (S203).

In a case where the operator inputs, to the product information input screen, the product type name and the product serial number which are heard from the customer (S204), the call center terminal 30 transmits the product type name and the product serial number to the customer management device 10 (S205). The customer management unit 11 of the customer management device 10 searches for the maintenance, information record that includes the product type name and the product serial number from the maintenance information storage unit 13 (S206). Next, the customer management unit 11 transmits the maintenance information record that is searched for to the maintenance component management device 20 (S207).

In a case where the maintenance component management unit 21 of the maintenance component management device 20 receives the maintenance information record, the maintenance component management unit 21 searches for the maintenance components that configure the product related to the maintenance information record (hereinafter referred to as “target product”) from the maintenance component list storage unit 24 (S208).

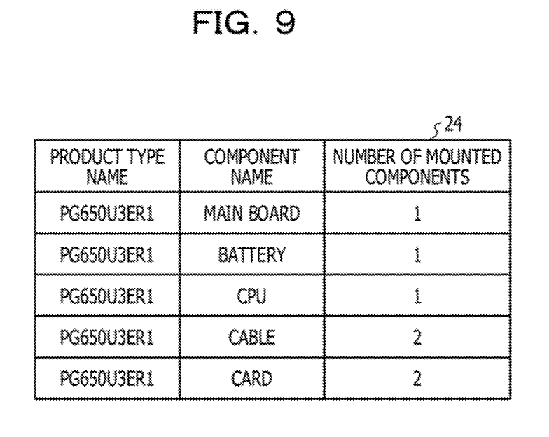

FIG. 9 is a diagram that illustrates a configuration example of the maintenance component list storage unit. In FIG. 9, each record of the maintenance component list storage, unit 24 (hereinafter referred to as “maintenance component record”) has items such as the product type name, a component name, and the number of mounted components. The product type name is the type name of the product. The component name is the name of the maintenance component that configures the product related to the product type name. The number of mounted components is the number of mounted maintenance components related to the component name in the product related to the product type name.

As illustrated in FIG. 9, as for the product that includes plural kinds of maintenance components, plural maintenance component records are stored. In step S208, all the maintenance component records related to the product type name of the target product are searched for.

Next, the maintenance component management unit 21 generates display data of a maintenance component shipment screen (S209). The maintenance component shipment screen is a screen for accepting designation of the maintenance component to be a shipment target. In step S209, the display data of the maintenance component shipment screen are generated such that the product information of the target product is displayed, the placement location information of the target product is displayed as the shipment destination of the maintenance component, and the catalog of the maintenance components that are searched for in step S208 is displayed as choices. The product information and the placement location information are acquired from the maintenance information record received in step S207. Next, the maintenance component management unit 21 transmits the display data to the call center terminal 30 (S210).

In a case where the call center terminal 30 receives the display data, the call center terminal 30 displays the maintenance component shipment screen based on the display data (S211). Next, the call center terminal 30 accepts the selection of the maintenance component as the shipment target from the operator via the maintenance component shipment screen (S212). Next, in a case where the shipment destination of the maintenance component (that is, the placement location of the target product) is changed, the call center terminal 30 accepts an input of information that indicates the shipment destination via the maintenance component shipment screen (S213). Next, the call center terminal 30 transmits, to the maintenance component management device 20, the component name of each of the maintenance components that is selected via the maintenance component shipment screen (that is, the component name of the shipment target) and information that indicates the shipment destination (which is an address or the like, for example, and will hereinafter be referred to as “shipment destination information”) (S214).

In a case where the maintenance component management unit 21 of the maintenance component management device 20 receives the component name of the shipment target and the shipment destination information, the maintenance component management unit 21 transmits a reference request for the placement location precision of the target product to the customer management device 10 (S215). The reference request includes the industry type name of the customer that is related to the target product and the model name of the target product. It is possible to acquire the industry type name of the customer that is related to the target product and the model name of the target product from the maintenance information record that is received in step S207.

In a case where the customer management unit 11 of the customer management device 10 receives the reference request, the customer management unit 11 searches for the placement location precision of the target product from the placement location precision storage unit 14 based on the industry type name and the model name that are included in the reference request (S216).

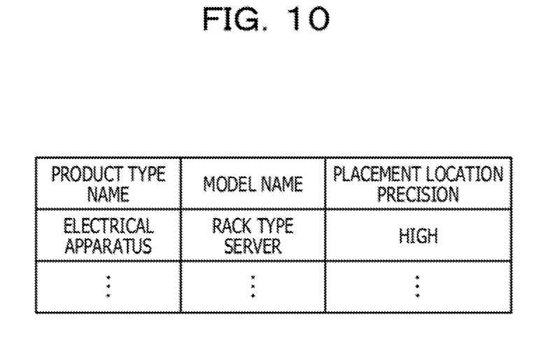

FIG. 10 is a diagram that illustrates a configuration example of the placement location precision storage unit. As illustrated in FIG. 10, the placement location precision storage unit 14 stores the placement location precision for each combination of the industry type name and the model name. In step S216, the placement location precision that corresponds to the combination of the industry type name and the model name that are included in the reference request is searched for from the placement location precision storage unit 14. Note that the placement location precision for each combination of the industry type name and the model name is assessed based on process procedures, that will be described later.

Next, the customer management unit 11 transmits the placement location precision that is searched for to the maintenance component management device 20 (S217). In a case where the maintenance component management unit 21 of the maintenance component management device 20 receives the placement location precision, the maintenance component management unit 21 executes the shipment process of the maintenance component that is selected as the shipment target about the target product (S218). In the shipment process, for example, a shipment instruction of the maintenance component is transmitted to the warehouse that is specified based on the placement location precision received in step S217 and the shipment destination information received in step S214. That is, in a case where the placement location precision is “high”, the shipment instruction is transmitted to the warehouse nearest to the placement location indicated by the shipment destination information. On the other hand, in a case where the placement location precision is “low”, the shipment instruction is transmitted to the block warehouse for the placement location indicated by the shipment destination information. Note that the nearest warehouse and the block warehouse for a certain location may be specified based on association information by in advance storing the association information between the name of a city, town, village, or the like and the identification information of the nearest warehouse and the block warehouse, for example. Alternatively, the nearest warehouse may be specified based on the direct distance from the newest placement location of the target product or may be specified based on a route search or the like from the newest placement location of the target product, for example. Information that indicates the nearest range is stored for each of the warehouses, and the nearest warehouse may thereby be specified based on the information.

Note that in a case where the maintenance component is actually shipped from the warehouse by the, shipment instruction, the number of inventories of the maintenance component in the warehouse, which is stored in the inventory information storage unit 25, is updated.

Next, the maintenance component management unit 21 stores information that indicates shipment results of the maintenance components in the shipment result storage unit 23 (S219).

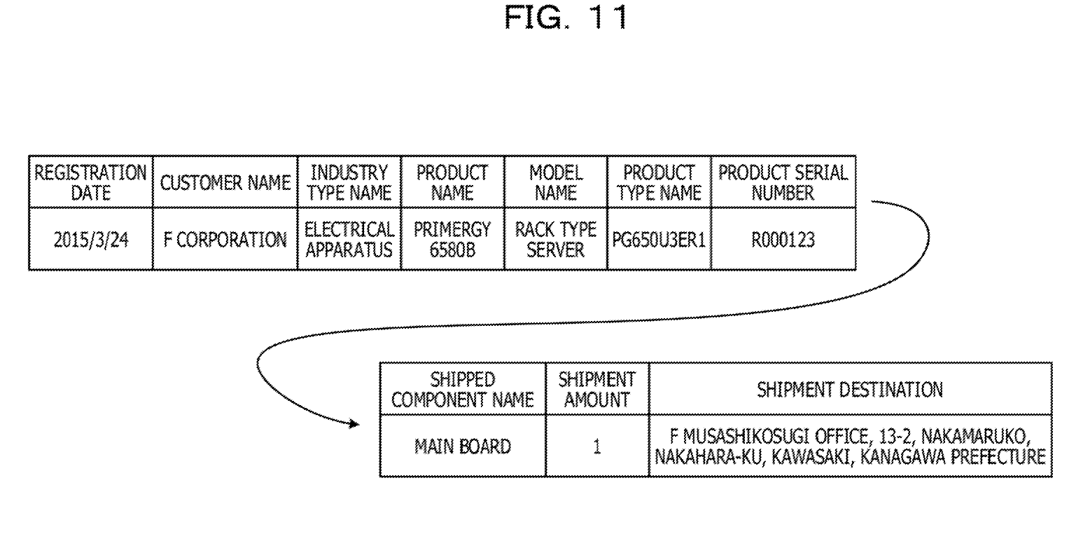

FIG. 11 is a diagram that illustrates a configuration example of a record, of the shipment result storage unit. As illustrated in FIG. 11, the record of the shipment result storage unit 23 (hereinafter referred to as “shipment result record”) includes items such as a registration date, the customer name, the industry type name, the product name, the model name, the product type name, the product serial number, a shipped component name, a shipment amount, and a shipment destination. The registration date is the year, month, and day when the shipment result record is registered. The customer name, the industry type name, the product name, the model name, the product type name, and the product serial number have the same meanings as the items with the same names in the maintenance information record (FIG. 7). Here, the values that are stored in the maintenance information record (FIG. 7) of the target product are stored. The shipped component name is the component name of the maintenance component that is shipped. The shipment amount is the shipment amount of the maintenance component. The shipment destination is information that indicates the shipment destination of the maintenance component. Here, the shipment destination information that is received in step S214 is stored as the value of the shipment destination. Note that the shipment result record is stored with respect to each of the component names of the maintenance components that are shipped. Therefore, in a case where plural maintenance components are shipped, plural shipment result records are stored in the shipment result storage unit 23.

Next, the maintenance component management unit 21 transmits display data of a maintenance component shipment completion screen to the call center terminal 30 (S220). In a case where the call center terminal 30 receives the display data, the call center terminal 30 displays the maintenance component shipment completion screen based on the display data (S221).

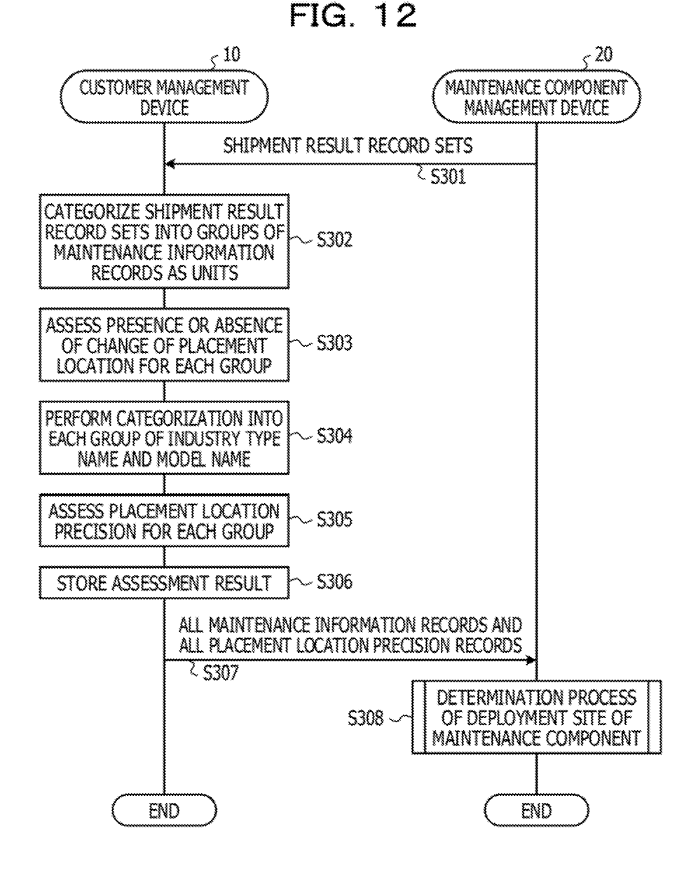

Next, an assessment process of the placement location precision will be described. FIG. 12 is a sequence diagram for explaining one example of process procedures of the assessment process of the placement location precision.

For example, in a case where periodically coming timing (for example, the beginning of a month, the end of a month, or the like) arrives, the maintenance component management unit 21 of the maintenance component management device 20 transmits all the shipment result records stored in the shipment result storage unit 23 to the customer management device 10 and requests the assessments about the placement location precisions (S301).

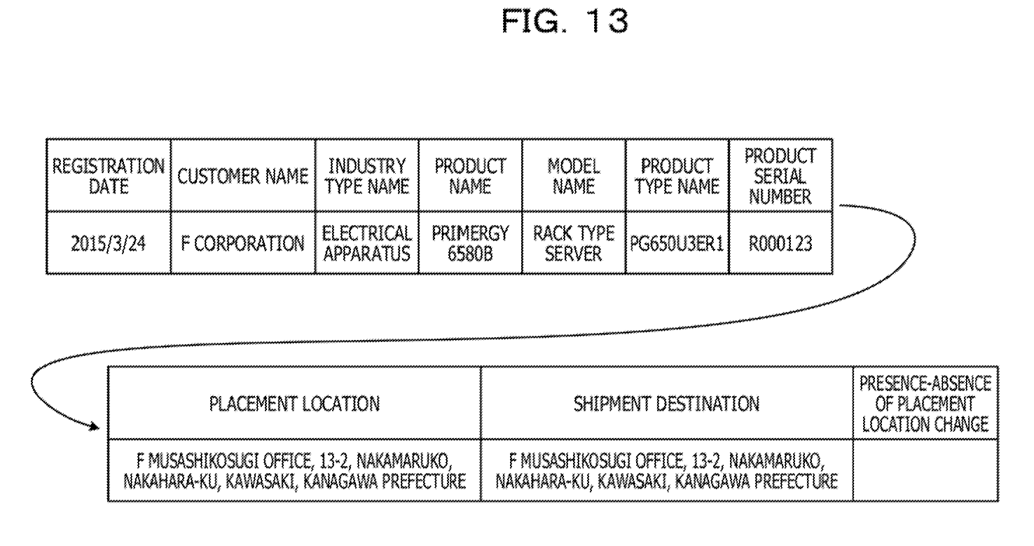

The placement location precision assessment unit 12 of the customer management device 10 answers the request and categorizes received shipment result record sets into groups with respect to the maintenance information records (S302). That is, the shipment result record sets are categorized into the groups of the individuals of the products as the maintenance targets. Next, the placement location precision assessment unit 12 assesses whether the change of the placement location is present or absent with respect to each of the groups (S303). For example, for each of the groups, data as illustrated in FIG. 13 may be generated.

FIG. 13 is a diagram that illustrates a configuration example of data which indicate presence or absence of the change of the placement location with respect to each of the products as the maintenance target. The data illustrated in FIG. 13 (hereinafter referred to as “product-specific change presence-absence data”) includes items of the shipment destination and presence-absence of placement location change in addition to each of the items of the maintenance information record (FIG. 7).

To the items common to the maintenance information record, the values of the respective items in the maintenance information record related to the group are transferred. To the shipment destination, the value of the shipment destination stored in the shipment result record, which is categorized into the group of the corresponding maintenance information record, is transferred. In a case where plural shipment result records are concerned, for example, the value of the shipment destination of the newest shipment result record may be adopted. The presence-absence of placement location change indicates presence or absence of a difference between the value of the placement location and the value of the shipment destination in the product-specific change presence-absence data. That is, the value of the placement location indicates the original placement location of the product that corresponds to the product-specific change presence-absence data. Further, the value of the shipment destination indicates the shipment destination of the maintenance component related to the product, but the shipment destination may be assumed as the newest placement location of the product. This is because the maintenance component is usually shipped to the placement location of the product. Therefore, the assessment of presence or absence of the change of the placement location of the product is possible by the difference or sameness between the value of the placement location and the value of the shipment destination. Note that in a case where it is not ensured that the shipment destination of the, maintenance component is the placement location of the product, the present placement location of the product, other than the shipment destination, may be stored in the shipment result record. In this case, the value of the presence-absence of placement location change of the product-specific change presence-absence data may be determined based on the, comparison between the value of the original placement location and the value of the present placement location.

Next, the placement location precision assessment unit 12 categorizes product-specific change presence-absence data sets into each group to which the industry type name and the model name are common (S304). Next, the placement location precision assessment unit 12 assesses or determines the placement location precision with respect to each of the categorized groups (S305). For example, the placement location precision of the group that includes even one piece of the product-specific change, presence-absence data whose value of the presence-absence of placement location change is “present” may be assessed as “low”, and the placement location precision of the group that does not include the product-specific change presence-absence data whose value of the presence-absence of placement location change is “present”may be assessed as “high”. Alternatively, the ratio of the number of pieces of the product-specific change presence-absence data whose value of the presence-absence of placement location change is “present” in the group to the number of all the pieces of the product-specific change presence-absence data in the group is compared with a threshold value, and the placement location precision may thereby be assessed. For example, in a case where the ratio is equal to or higher than the threshold value, the placement location precision may be assessed as “low”. In a case where the ratio is less than the threshold value, the placement location precision may be assessed as “high”. Alternatively, the ratio of the number of pieces of the product-specific change presence-absence data whose value of the presence-absence of placement location change is “absent” in the group to the number of all the pieces of the product-specific change presence-absence data in the group is compared with a threshold value, and the placement location precision may thereby be assessed. For example, in a case where the ratio is equal to or higher than the threshold value, the placement location precision may be assessed as “high”. In a case where the ratio is less than the threshold value, the placement location precision may be assessed as “low”. The placement location precision may be assessed by other methods.

Next, the placement location precision assessment unit 12 stores; the assessment result of the placement location precision in the placement location precision storage unit 14 (FIG. 10) (S306). In a case where a record about the same industry type name and the same model (hereinafter referred to as “placement location precision record”) is already stored in the placement location precision storage unit 14, the existing placement location precision record is overwritten by a new assessment result.

Next, the placement location precision assessment unit 12 transmit, to the maintenance component management device 20, all the maintenance information records that are stored in the maintenance information storage unit 13 and all the placement location precision records that are stored in the placement location precision storage unit 14 (S307). In a case where the deployment site determination unit 22 of the maintenance component management device 20 receives those records, the deployment site determination unit 22 executes a determination process of the deployment site of each of the maintenance component (S308).

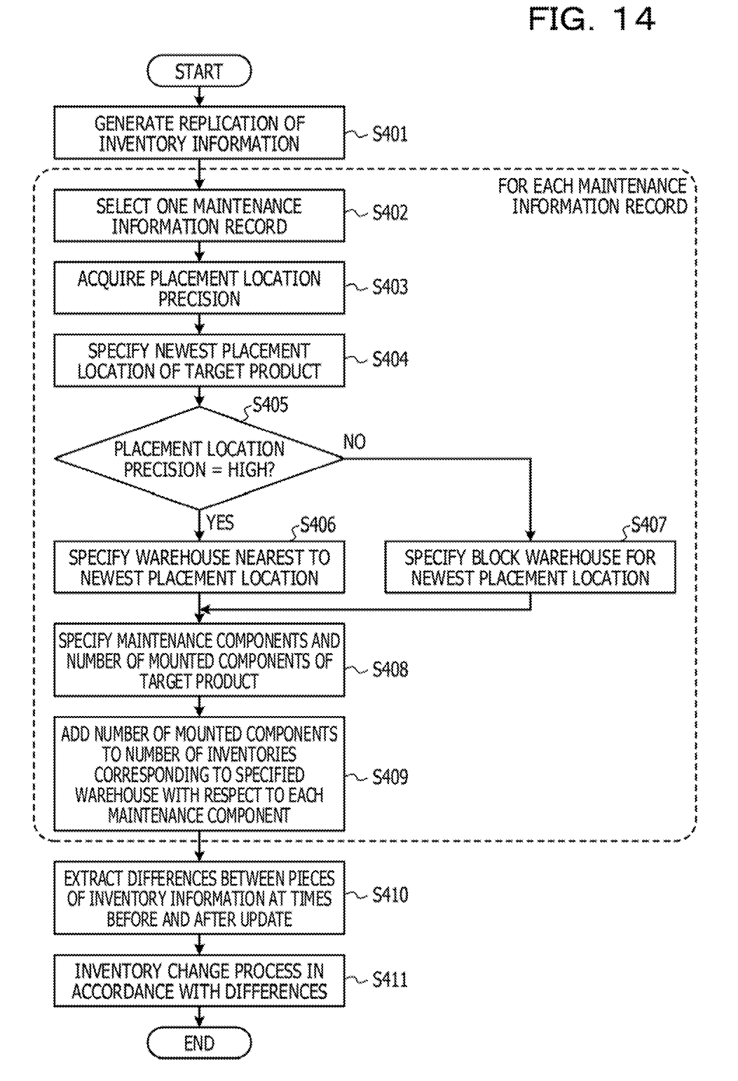

Next, details of step S308 will be described. FIG. 14 is a flowchart for explaining one example of process procedures of the determination process of the deployment site of the maintenance component.

In step S401, the deployment site determination unit 22 generates a replication of stored contents of the inventory information storage unit 25.

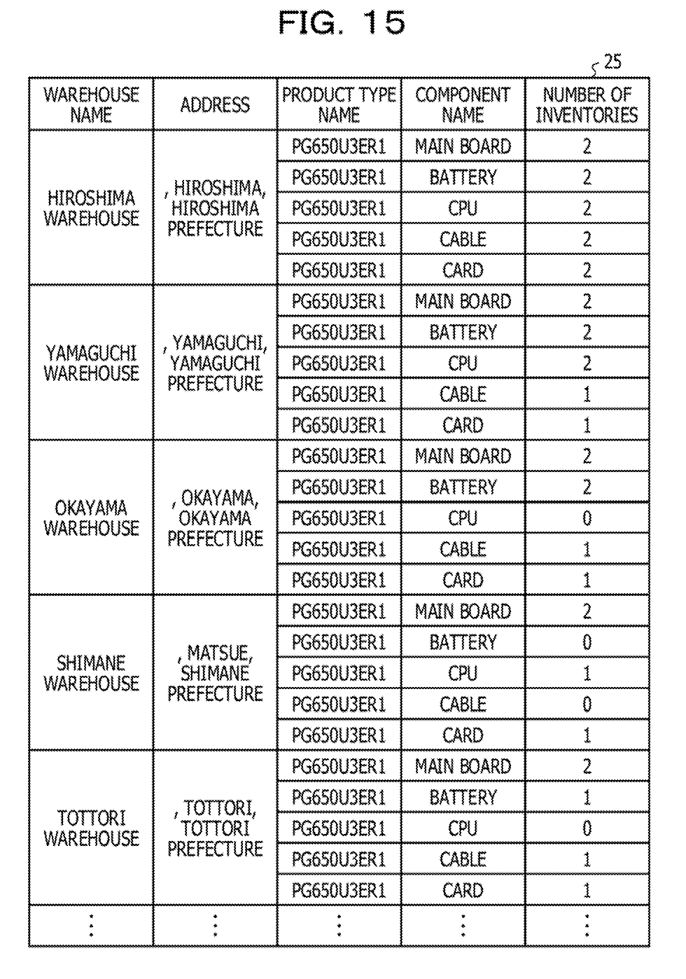

FIG. 15 is a diagram that illustrates a configuration example of the inventory information storage unit. As illustrated in FIG. 15, in the inventory information storage unit 25, a warehouse name and an address are stored with respect to each of the warehouses, and the product type name, the component name, and the number of inventories are stored with respect to each of the maintenance component that is deployed to the warehouse.

The warehouse name is an identification name of the warehouse. The address is the address where the warehouse is located. The product type name is the type name of the product to which the maintenance component belongs. The component name is the name of the maintenance component. The number of inventories is the number of inventories of the maintenance components.

In step S401, after replications of all the records that are stored in the inventory information storage unit 25 are generated, the number of inventories of each record of the replication (hereinafter referred to as “replication inventory information”) is initialized to zero.

Next, the deployment site determination unit 22 selects one of the received maintenance information record sets as a process target (S402). In the following, “maintenance information record” that is simply used will represent the maintenance information record that is selected in step S402. Further, the product related to the maintenance information record will be referred to as “target product”.

Next, the deployment site determination unit 22 acquires the value of the placement location precision of the placement location precision record that corresponds to the industry type name and the model name of the maintenance information record among received placement location precision record sets (S403). The acquired value is the placement location precision of the target product.

Next, the deployment site determination unit 22 specifies the newest placement location of the target product (S404). The newest placement location may be specified by referring to the shipment destination of the newest shipment result record among the shipment result records about the target product, which are stored in the shipment result storage unit 23. In a case where no shipment result record about the target product is present, the newest placement location of the target product may be specified by referring to the placement location of the maintenance information record.

Next, the deployment site determination unit 22 assesses whether or not the value of the placement location precision of the target product is “high” (S405). In a case where the, value of the placement location precision is “high” (Yes in S405), the deployment site determination unit 22 specifies the warehouse nearest to the newest placement location of the target product (S406).

On the other hand, in a case where the value of the placement location precision is not “high” (No in S405), the deployment site determination unit 22 specifies the block warehouse for the newest placement location of the target product (S407). For example, the block warehouse of the block (region) to which the newest placement location of the target product belongs is specified.

Next, the deployment site determination unit 22 refers to the maintenance component list storage unit 24 (FIG. 9) and specifies the maintenance components that belong to the target product and the numbers of mounted components of the maintenance components (S408). Next, in the replication inventory information, the deployment site determination unit 22 respectively adds the numbers of the mounted maintenance components to the numbers of inventories of the records that correspond to the maintenance components among the records of the individual maintenance components that are included in the records which correspond to the warehoused specified in step S406 or S407 (S409).

Steps S402 to S409 are executed for all the received maintenance information records (that is, for all the products as the maintenance targets).

Next, the deployment site determination unit 22 extracts the differences between the contents of the replication inventory information and the stored contents of the inventory information storage unit 25 (S410). For example, the increases, decreases, and so forth in the numbers of inventories are extracted. Next, the deployment site determination unit 22 executes a change process of the inventories in each of the warehouses in accordance with the differences (S411). For example, to each of the warehouses that are related to the differences, a change instruction of the number of inventories of the maintenance components related to the differences is transmitted. That is, step S411 is a process for causing the contents of the replication inventory information to match the actual numbers of inventories in each of the warehouses. Note that update of the inventory information storage unit 25 is executed in response to the actual movement of the maintenance components.

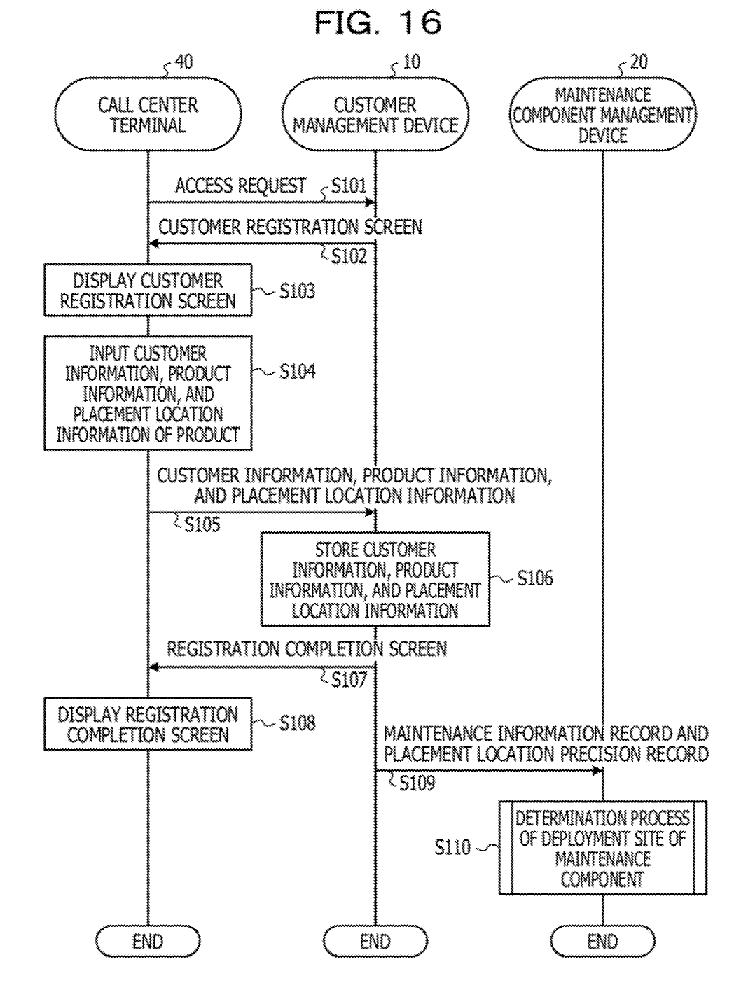

Next, a description will be made about process procedures that are not described in 9G. 6 for convenience of description. FIG. 16 is a sequence diagram for explaining one example of second process procedures of the registration process of the customer information. In FIG. 16, the same step numbers will be given to the same steps as FIG. 6, and detailed descriptions thereof will not be made.

Although a description is not made in FIG. 6, following step S107, the customer management unit 11 transmits the maintenance information record that is newly registered and the placement location precision record that corresponds to the maintenance information record to the maintenance component management device 20 (S109). The deployment site determination unit 22 of the maintenance component management device 20 executes the process procedures described in FIG. 14 for the maintenance information record (S110). As a result, the maintenance components for the product that is newly registered are deployed to the warehouse nearest to the placement location of the product or the block warehouse.

As described above, in this embodiment, the placement location precision is assessed with respect to each combination of the kind (model) of the product and the industry type of the user of the product based on the history information of the placement location of the product (the original placement location and the shipment destination of the maintenance component). The deployment site of the maintenance component of each of the products is determined based on the placement location precision of each of the products. That is, the maintenance components of the product with a high possibility of movement are deployed to the block warehouse, and the maintenance components of the product with a low possibility of movement are deployed to the nearest warehouse. As a result, occurrence of a delay in procurement of a component becomes avoidable while an increase in the number of inventories of components is suppressed. Further, for example, a case may be inhibited where as a result of arrangement of the maintenance, components of the product to the warehouse nearest to the original placement location, the placement location of the product is moved, the distance between the location of the warehouse in which the components are arranged and the actual placement location of the product thereby becomes long, and procurement of the component is delayed.

Note that in this embodiment, a description is made about an example where the placement location precision is assessed with respect to each combination of the model and the industry type. However, the placement location precision may be assessed with respect to each model or each industry type. Further, the placement location precision may be assessed with respect to each category of the product based on other viewpoints (criteria).

Note that in this embodiment, the placement location precision assessment unit 12 is one example of a first determination unit. The deployment site determination unit 22 is one example of a second determination unit. The customer management device 10 and the maintenance component management device 20 are one example of an inventory deployment site determination device. The placement location precision is one example of an index value about the possibility that the placement location is changed.

In the foregoing, the embodiment of the present disclosure has been described in detail. However, the present disclosure is not limited to the specific embodiment, but various modifications and alterations are possible within the scope of the gist of the present disclosure that is described in the claims,

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A non-transitory computer-readable recording medium recording an inventory deployment site determination program that causes a computer to execute a process, the process comprising:
determining an index value about a possibility that a placement location for each of products to be maintenance targets is changed based on history information of placement locations of the products; and
determining, for each of the products, a warehouse as a deployment site of an inventory of a component of the respective products based on the index value that corresponds to the respective products.

2. The non-transitory computer-readable recording medium according to claim 1, wherein
the history information includes a kind of a product, an industry type of a user of the product, a placement location in registered information of a maintenance service of the product, and a placement location in a case where maintenance work for the product is performed,
the determining of the index value determines the index value for each of combinations of the kind of respective products and the industry type of the user of the respective products based on the history information.

3. The non-transitory computer-readable recording medium according to claim 2, wherein the determining of the warehouse determines, for each of the products, the warehouse as the deployment site of the inventory of the component of the respective products based on the index value that is determined for the respective combinations.

4. The non-transitory computer-readable recording medium according to claim 1, wherein, the determining of the warehouse determines, based on the index value, one of a warehouse nearest to the placement location of the respective products and a warehouse that is selected in an area to which the placement location of the respective products belongs from among areas each including warehouses as the deployment site of the inventory of the component of the respective products.

5. An information processing apparatus, comprising:
a memory that stores an inventory deployment site determination program; and
a processor, based on the an inventory deployment site determinations program, perform operations of:
determining an index value about a possibility that a placement location for each of products to be maintenance targets is changed based on history information of placement locations of the products; and
determining, for each of the product, a warehouse as a deployment site of an inventory of a component of the respective products based on the index value that corresponds to the respective products.

6. The information processing apparatus according to claim 5, where
the history information includes a kind of a product, an industry type of a user of the product, a placement location in registered information of a maintenance service of the product, and a placement location in a case where maintenance work for the product is performed,
the determining of the index value determines the index value for each of combinations of the kind of respective products and the industry type of the user of the respective products based on the history information.

7. The information processing apparatus according to claim 6, wherein the determining of the warehouse determines, for each of the products, the warehouse as the deployment site of the inventory of the component of the respective products based on index value that is determined for the respective combinations.

8. The information processing apparatus according to claim 5, wherein, the determining of the warehouse determines, based on the index value, one of a warehouse nearest to the placement location of the respective products and a warehouse that is selected in an area to which the placement location of the respective products belongs from among areas each including warehouses as the deployment site of the inventory of the component of the respective products.

9. An inventory deployment site determination method comprising:
determining, by a computer, an index value about a possibility that a placement location for each of products to be maintenance targets is changed based on history information of placement locations of the products; and
determining, for each of the product, a warehouse as a deployment site of an inventory of a component of the respective products based on the index value that corresponds to the respective products.

10. The inventory deployment site determination method according to claim 9, wherein
the history information includes a kind of a product, an industry type of a user of the product, a placement location in registered information of a maintenance service of the product, and a placement location in a case where maintenance work for the product is performed,
the determining of the index value determines the index value for each of combinations of the kind of respective products and the industry type of the user of the respective products based on the history information.

11. The inventory deployment site determination method according, to claim 10, wherein the determining of the warehouse determines, for each of the products, the warehouse as the deployment site of the inventory of the component of the respective products based on the index value that is determined for the respective combinations.

12. The inventory deployment site determination method according to claim 9, wherein, the determining of the warehouse determines, based on the index value, one of a warehouse nearest to the placement location of the respective products and a warehouse that is selected in an area to which the placement location of the respective products belongs from among areas each including warehouses as the deployment site of the inventory of the component of the respective products.
